(19) United States
(12) Patent Application Publication
(10) Pub. No.: US 2014/0308574 A1
(43) Pub. Date: Oct. 16, 2014

(54) PRINTED BATTERIES

(71) Applicant: Varta Microbattery GmbH, Ellwangen (DE)

(72) Inventors: David Ensling, Ellwangen (DE); Edward Pytlik, Ellwangen (DE); Hans Juergen Lindner, Ellwangen (DE)

(21) Appl. No.: 14/359,934

(22) PCT Filed: Nov. 21, 2012
(86) PCT No.: PCT/EP2012/073199

§ 371 Date: May 22, 2014

(30) Foreign Application Priority Data
Nov. 22, 2011 (DE) 10 2011 086899.2

(51) Int. Cl. H01M 4/04

(52) U.S. Cl. CPC H01M 4/0402; H01M 4/0471
USPC 429/164; 429/163; 427/487; 427/58

(57) ABSTRACT

A process of producing a battery having a housing and a three-dimensional electrode-separator assembly includes at least one first electrode, at least one second electrode having the opposite polarity to the first, at least one separator physically separating the first electrode and the second electrode and optionally at least one power outlet lead arranged therein is described. The assembly is built up in layers by sequentially printing two-dimensional layers of a first electrode dispersion to produce the at least one first electrode and/or a second electrode dispersion to produce the at least one second electrode and/or a separator dispersion to produce the at least one separator and/or at least one power outlet lead dispersion to produce the at least one power outlet lead on top of one another.

### TECHNICAL FIELD

This disclosure relates to a process of producing a battery having a housing and a three-dimensional electrode-separator assembly arranged therein and also to batteries produced by the process.

### BACKGROUND

The term “battery” originally meant a plurality of electrochemical cells connected in series. However, nowadays, single electrochemical cells are also referred to as batteries. When an electrochemical cell is discharged, an energy-providing chemical reaction made up of two subreactions electrically coupled to one another but are separated in space takes place. Electrons are released in an oxidation process at the negative electrode, resulting in an electron current via an external load to the positive electrode by which a corresponding number of electrons is taken up. A reduction process thus takes place at the positive electrode. At the same time, an ion current corresponding to the electrode reaction flows within the cell. This ion current is ensured by an ion-conducting electrolyte. In secondary cells and batteries, this discharging reaction is reversible, and it is thus possible to reverse the conversion of chemical energy into electric energy which occurs during discharging.

Batteries occur in wide varieties. The respective application is decisive in determining the type of construction and the size of batteries. Thus, batteries weighing several tons have been developed as emergency power supplies for industrial applications. On the other hand, in the consumer sector, there are batteries having weights of a few grams or even only a few milligrams.

In particular, the construction of particularly small and flat batteries, as are frequently required by miniaturized electronic components and appliances, means that battery constructors are every now and again faced with challenges. Thus, for example, batteries described in DE 101 62 832 A1, DE 102 19 424 A1 and DE 10 2005 017 682 A1 have been developed for specific applications, e.g., energy supply for smart tags, smart labels or smart cards. The batteries described in the last of these documents can be produced, in particular, by printing.

Specific difficulties occur, in particular, in cases in which existing battery systems are to be miniaturized further without making a change in their basic construction. An example is prismatic cells or button cells. Although the dimensions of individual functional parts of such batteries, e.g., the housing, the separator and the electrodes, can frequently be scaled down substantially, the assembly thereof, for example, the precise placing of electrodes and separator in a miniaturized button cell housing, is then difficult.

It could therefore be helpful to provide button cells and prismatic cells, in particular, to be miniaturized without the construction thereof having to be fundamentally modified for this purpose.

### SUMMARY

We provide a process of producing a button cell having a housing and a three-dimensional electrode-separator assembly arranged therein, wherein the electrode-separator assembly includes a first electrode, a second electrode having an opposite polarity to the first electrode and a separator separating the first electrode and the second electrode, the process including forming the assembly by sequentially printing two-dimensional layers with a first electrode dispersion that produces the first electrode and/or a second electrode dispersion that produces the second electrode and/or a separator dispersion that produces the separator on top of one another, wherein the layers each are printed either from only one of the dispersions or from a plurality of the dispersions.

We also provide a process of producing a button cell having a housing and a three-dimensional electrode-separator assembly arranged therein, wherein the electrode-separator assembly includes a first electrode, a second electrode having an opposite polarity to the first electrode and a separator separating the first electrode and the second electrode, the process including forming the assembly by sequentially printing two-dimensional layers with a first electrode dispersion that produces the first electrode and/or a second electrode dispersion that produces the second electrode and/or a separator dispersion that produces the separator on top of one another, wherein the two-dimensional layers are printed directly into the housing or into a part of the housing.

We further provide a process of producing a button cell having a housing and a three-dimensional electrode-separator assembly arranged therein, wherein the electrode-separator assembly includes a first electrode, a second electrode having an opposite polarity to the first electrode and a separator separating the first electrode and the second electrode, the process including forming the assembly by sequentially printing two-dimensional layers with a first electrode dispersion that produces the first electrode and/or a second electrode dispersion that produces the second electrode and/or a separator dispersion that produces the separator on top of one another, wherein the assembly is, after it has been built up, transferred into the housing.

We still further provide a process of producing a battery having a housing and a three-dimensional electrode-separator assembly arranged therein, where the electrode-separator assembly includes at least one first electrode, at least one second electrode having the opposite polarity to the first, at least one separator physically separating the at least one first electrode and the at least one second electrode and, optionally, at least one power outlet lead, the process comprising forming the assembly by sequentially printing two-dimensional layers with a first electrode dispersion that produces the at least one first electrode and/or a second electrode dispersion that produces the at least one second electrode and/or a separator dispersion that produces the at least one separator and/or at least one power outlet dispersion that produces the at least one power outlet lead on top of one another.

We further yet provide a battery having a housing and a three-dimensional electrode-separator assembly arranged therein, produced as in the process of producing a button cell having a housing and a three-dimensional electrode-separator assembly arranged therein, wherein the electrode-separator assembly includes a first electrode, a second electrode having an opposite polarity to the first electrode and a separator separating the first electrode and the second electrode, the process including forming the assembly by sequentially printing two-dimensional layers with a first electrode dispersion that produces the first electrode and/or a second electrode dispersion that produces the second electrode and/or a separator dispersion that produces the separator on top of one another, wherein the layers each are printed either from only one of the dispersions or from a plurality of the dispersions.

### BRIEF DESCRIPTION OF THE DRAWINGS

FIG. 1 schematically shows one example of our process.

FIG. 2 schematically shows another example of our process.

### DETAILED DESCRIPTION

Our process produces batteries having a housing and a three-dimensional electrode-separator assembly arranged therein, the latter having
at least one first electrode,
at least one second electrode having the opposite polarity to the first and
at least one separator physically separating the first electrode and the second electrode.

Such assemblies are, for example, known from prismatic cells or from button cells. Prismatic cells usually have film-like electrodes and separators joined to one another over their area to form an assembly having the sequence positive electrode/separator/negative electrode. In button cells, a generally disk-shaped separator forms an assembly with two electrodes having the opposite polarity. In contrast to prismatic cells, the ratio of the electrode masses to the area of the separator is, however, very much greater.

Preferably, the electrode-separator assembly can also comprise:
one or more power outlet leads in electrical contact with the at least one first electrode and/or with the at least one second electrode.

In the case of prismatic cells, the power outlet leads are usually meshes or foils made of metal. In the case of the positive electrode in lithium ion cells, they are, in particular, meshes or foils made of aluminum. In the case of the negative electrode in lithium ion cells, they are, in particular meshes or foils made of copper. The assembly can, for example, have the sequence first power outlet lead/positive electrode/separator/negative electrode/second power outlet lead. In button cells, power outlet leads are not absolutely necessary since the electrode compositions are usually in direct contact with the poles of the button cell (the housing parts). For example, in the case of metal-air button cells having an air cathode, this normally comprises, however, a power outlet lead.

Our process is, in particular, characterized in that the assembly of electrodes and separator is built up in layers by sequentially printing two-dimensional layers of
a first electrode dispersion and a second electrode dispersion to produce the electrodes,
a separator dispersion to produce the at least one separator and
optionally, a power outlet lead dispersion to produce the at least one power outlet lead on top of one another. Thus, prefabricated functional parts are not combined to produce the assembly, but instead, the electrodes and the separator and also optionally the power outlet lead or leads are formed in direct contact with one another. Depending on the thickness of the two-dimensional layers and the desired thickness of the assembly components to be printed, a plurality of printing operations are required in each case to produce the individual components, for example, the separator.

With each printed layer, the thickness of the component to be printed and thus of the assembly increases perpendicular to the plane of the printed layers. In principle, layer assemblies having any thickness can be produced in this way.

Preference is given to the two-dimensional layers being printed in a thickness of 1 μm to 500 μm, preferably 10 μm to 300 μm, with these values being based on the wet film thickness of the layers before drying.

As printing processes for printing the two-dimensional layers, preference is given to using “ink jet printing” or “microdispensing” in which defined amounts of the abovementioned dispersions are dispensed through one or more discharge openings. In these processes, the dispersions can be transferred from a reservoir into a printing head whose key component is a capillary which typically opens into a very thin capillary point (nozzle). From this, the dispersion is ejected in droplet form, usually driven by piezoelectrically produced shock waves or pressure waves as a result of vaporization of dispersion medium.

In the latter case, which is also known as a bubble-jet process, brief heating pulses act on the dispersion present in the capillary. This produces a vapor bubble exerting a high pressure on the dispersion. As the bubble increases in size, the pressure in the nozzle continues to increase until the bubble flings out a droplet of dispersion through the nozzle. The vapor bubble subsequently condenses, as a result of which a subatmospheric pressure is generated downstream of the nozzle by which a continuing flow of the dispersion from the reservoir is achieved.

In the case of piezoelectric processes, the capillary is surrounded by a piezoelectric actuator immediately before the point and this actuator transmits electric pulses as pressure pulses through the capillary walls to the dispersion present in the capillary. The pressure pulses trigger shock waves in the dispersion, as a result of which dispersion leaves the capillary point in droplet form. A very fast sequence of droplets can be generated by appropriate high-frequency operation of the actuator so that, although the volume of individual droplets is typically not large, relatively large amounts of dispersion can also be discharged perfectly well.

It is possible for the electrode-separator assembly to be built up exclusively of two-dimensional layers which have each been printed from only one of the dispersions. This variant of the process is, for example, employed when simple, classical structures in which a flat separator layer is arranged between two flat electrode layers are to be produced.

More complex structures can be produced when the assembly is made up at least partly of two-dimensional layers which have been printed using a plurality of the dispersions. Thus, for example, it is possible for an electrode-separator assembly to be built up in layers by printing a plurality of layers having an identical base area and each having cut-outs at the same predefined positions on top of one another using a separator dispersion and filling these cut-outs partially with the first electrode dispersion and partially with the second electrode dispersion. Superposition of cut-outs which have been filled with the same electrode dispersion makes it possible to obtain structures in which electrodes or parts of electrodes extend perpendicularly to the layer planes over a plurality of layers. This procedure is explained in more detail with the aid of the drawings.

Important parameters in the process are the nature and constitution of the dispersions used.

The first electrode dispersion comprises a dispersion medium and a first electrochemical active material dispersed therein. Preferably, a conductivity improver and a first electrode binder can be present in the dispersion, either alone or in combination. The electrode binder can be dissolved in the dispersion medium and, in this case, it is more correct to speak of a dispersion medium and/or solvent. The first electrochemical active material is preferably present in the electrode dispersion in a proportion of 1% by weight to 75% by weight, preferably <20% by weight.

The second electrode dispersion comprises a dispersion medium and a second electrochemical active material dispersed therein. Preferably, a conductivity improver and a second electrode binder can be present in the dispersion, either alone or in combination. Here too, the electrode binder can be dissolved in the dispersion medium and, in this case it would, here, too, be more correct to speak of a dispersion medium and/or solvent. The second electrochemical active material is preferably present in the electrode dispersion in a proportion of 1% by weight to 75% by weight, preferably <20% by weight.

The separator dispersion comprises a dispersion medium and electrically nonconductive fibers and/or particles dispersed therein. The electrically non-conductive fibers and/or particles are preferably present in the separator dispersion in a proportion of 1% by weight to 75% by weight, preferably less than 20% by weight. Preferably, a separator binder can be present.

The power outlet lead dispersion comprises a dispersion medium and electrically conductive fibers and/or particles dispersed therein. The electrically conductive fibers and/or particles are preferably present in the power outlet lead dispersion in a proportion of 1% by weight to 75% by weight, preferably <20% by weight. Preferably, a power outlet lead binder can be present. This, too, can optionally be dissolved in the dispersion medium.

Which dispersion medium is selected for the individual dispersions depends quite substantially on the other components thereof, in particular on the binder present in the dispersions and in the case of the electrode dispersions in particular on which electrochemical active materials are present. Basically, possible dispersion media are water and also organic solvents such as N-methylpyrrolidone (NMP), dimethyl sulfoxide, dimethylformamide, dimethylacetamide, acetone or N-ethylpyrrolidone (NEP). Which electrochemical active materials are selected for the electrode dispersions again depends on which cell chemistry the battery to be produced is to have.

If, for example, the battery to be produced is to be a lithium ion cell, all known materials used in positive electrodes for lithium ion batteries, in particular lithium-cobalt oxide (LiCoO₂), lithium-manganese oxide (LiMnO₂), LiMn₂O₄ spinel (LiMn₂O₄), lithium-iron phosphate (LiFePO₄), and also derivatives such as LiNi_{1/3}Mn_{1/3}Co_{1/3}O₂ or LiMnPO₄, are possible as first electrochemical active material. As second electrochemical active material corresponding thereto, it is in principle possible to use all materials which can take up lithium ions and release them again, for example, particles based on carbon (graphitic carbon) or nongraphitic carbon materials capable of intercalating lithium, e.g., lithium-titanate oxide (Li₄Ti₅O₁₂) and titanium dioxide (TiO₂). As an alternative or in addition thereto, metallic and semimetallic materials which can be alloyed with lithium can also be used, e.g., the elements tin, antimony and silicon.

If the battery to be produced is a metal-air cell, possibilities for the first electrochemical active material are, in particular, catalyst materials such as palladium, platinum, silver or gold and/or a manganese oxide as is described, for example, in DE 37 22 091 A1. As second electrochemical active material corresponding thereto, a suitable second electrode dispersion then comprises, for example, metallic particles such as zinc particles.

If the battery to be produced is an alkaline cell, possibilities for the first electrochemical active material are, in particular, zinc or zinc oxide (ZnO), and possibilities as second electrochemical active material corresponding thereto are, for example, nickel or nickel hydroxide (NiOH).

As a conductivity improver, it is in principle possible to use all known conductivity-improving additives for battery electrodes both for the first electrode dispersion and for the second electrode dispersion. Examples are carbon black or nickel powder.

The electrode binder for the first electrode dispersion and/or the second electrode dispersion is usually selected as a function of the electrochemical active material. Thus, for example, fluoro polymers such as polyvinylidene fluoride or polyvinylidene difluoride are suitable as binders for the electrodes of lithium ion cells. These polymers can, for example, be processed in N-methylpyrrolidone. As a binder which can be processed in an aqueous medium for lithium ion batteries, it is possible to use, for example, SBR (styrene-butadiene rubber) binders and sodium carboxymethylcellulose (CMC). The latter is also very well suited as electrode binder for the metal anodes of metal-air batteries, while polymers such as the abovementioned fluoro polymers are also possible as electrode binders for the positive electrode (air cathode) of such cells. Pastes for producing air cathodes of metal-air cells are described in DE 10 2011 007 297.7. Those pastes can, at least in diluted form, in principle also be used as electrode dispersion in our process. They generally comprise a polar solvent or dispersion medium such as water, the abovementioned noble metals or manganese oxides, a hydrophobic polymer, in particular fluoro polymer particles, as binder, and also a particulate conductivity-improving additive from the group consisting of carbon nanotubes, carbon black and metal particles (nickel) as conductivity improver. The fluoro polymer is preferably present in the form of PTFE particles (particles composed of polytetrafluoroethylene) which owing to their chemical stability and their hydrophobic character are particularly well suited.

That separators can also be produced by printing is described in DE 10 2010 018 071.8. That proposes a paste comprising a solvent or dispersion medium and also particles and/or fibers which are at least almost, preferably completely, insoluble in the solvent or dispersion medium at room temperature and are at the same time electrically nonconductive for printing separators. The paste can, at least in diluted form, in principle also be used as separator dispersion in our process.

The particles and/or fibers present in a corresponding separator dispersion can, in the printing process, form a three-dimensional matrix which gives the resulting separator a solid structure and a sufficiently high mechanical strength to prevent contacts between electrodes having opposite polarities.

The particles and/or fibers present in a corresponding separator dispersion can in principle consist either of an organic solid or of an inorganic solid. It is also possible, for example, to mix fibers of organic materials with inorganic particles or vice versa. The inorganic solid preferably comprises at least one component from the group consisting of ceramic solids, salts which are almost or completely insoluble in water, glass, basalt or carbon. The term “ceramic solids” is intended to encompass all solids which can serve to produce ceramic products, including siliceous materials such as aluminum silicates, glasses and clay minerals, oxidic raw materials such as titanium dioxide, silicon dioxide and aluminum oxide and also nonoxidic materials such as silicon carbide or silicon nitride. “Fiber” describes elongated structures which are very thin compared to their length. Fibers which are particularly well suited are fibers of synthetic polymers, e.g., polyamide fibers or polypropylene fibers. As an alternative, it is also possible to use fibers of inorganic or organic origin, for example, glass fibers, ceramic fibers, carbon fibers or cellulose fibers.

The solubility of the particles and/or fibers which can be used, in particular the abovementioned salts which are almost or completely insoluble in water, should ideally not exceed the solubility of calcium carbonate in water at room temperature (25° C.). Calcium carbonate is a particularly preferred example of an inorganic solid which can be present as component having a spacer function, in particular in particle form, in a separator dispersion.

The solvent or dispersion medium present in a separator dispersion of this type is preferably a polar solvent, for example, water. However, it is in principle also possible to use nonaqueous aprotic solvents as are known from the field of production of lithium ion batteries (see, for example, the abovementioned solvents).

The electrolyte salt described in DE 10 2010 018 071.8 does not necessarily have to be present in a separator dispersion suitable for our process. When it is present, it is preferably at least one compound which at room temperature is soluble in the dispersion medium or solvent or is present in the form of solvated ions in this dispersion medium or solvent. It comprises, for example, at least one component from the group consisting of zinc chloride, potassium hydroxide and sodium hydroxide. Furthermore, electrolyte salts such as lithium hexafluorophosphate or lithium tetrafluoroborate, which are likewise known, in particular, from the field of lithium ion batteries, may also be used as electrolyte salt.

The separator binder gives the separator, which can be produced from the separator dispersion, better mechanical stability, in particular, better mechanical strength and flexibility. Suitable separator binders are, for example, carboxymethylcellulose, SBR binders, PVDF-based binders or inorganic components having binding properties, e.g., silicon dioxide.

Dispersions which can be used as power outlet lead dispersions have been known for a long time. These are usually dispersions containing, for example, metallic particles such as silver, gold, copper, aluminum or nickel particles as electrically conductive fibers and/or particles. Suitable power outlet lead binders are, for example, a PVDF-based binder or CMC and SBR. As dispersion medium, it is possible to use, in particular, NMP or NEP, acetone or water.

All dispersions which can be used in our process can comprise one or more additives in addition to the components mentioned. These serve, in particular, to vary the processing properties of the dispersions. For example, all additives which can be used in the field of ink jet inks can be used as additives, for example, rheology modifiers by which the viscosity of the dispersions can be adapted.

All particles and/or fibers in the dispersions should ideally have an average diameter, or in the case of fibers an average length of 0.1 μm to 50 μm. The dispersions are particularly preferably free of particles and/or fibers having a diameter and/or a length of more than 100 μm. These values are based on the fact that particles and/or fibers which are too large can block the nozzles usually employed in ink-jet printing.

Preferably, the dispersions can contain a crosslinkable polymer or a polymerizable polymer precursor which can crosslink or polymerize under the action of heat and/or radiation as binder. Preference is given to two-dimensional layers which have been printed using such a dispersion being heated and/or irradiated before they are overprinted.

The overprinting of a layer is in principle problematic when it does not have a certain basic mechanical strength. Such a basic mechanical strength can be obtained by curing or polymerization of the polymer or of the polymer precursor. Suitable crosslinkable binders are, for example, polyimide resins as are described in US 2011/0111292 A1, in particular the polyamideimides, polyetheramideimides, polyetherimides, polyetherimide esters described therein or mixtures of these compounds.

Such a polymerizable or crosslinkable binder can be the only binder in one of the dispersions, but can also be used in combination with other binders, for example, the fluoro polymers mentioned.

It is naturally also possible to overprint layers not containing any crosslinkable polymer or any polymerizable polymer precursor. However, in such cases, dispersion medium present in the two-dimensional layer to be overprinted should be at least partly, preferably completely, removed before overprinting.

The proportion of binder in the dispersions is, preferably, 5% by weight to 60% by weight. In this case, drying steps are virtually indispensable. However, if the binder content of the dispersions is increased, in particular to values of >60% by weight, it may also be possible to overprint moist layers. Particularly preferably, the printed layers are compacted, i.e., subjected to pressure, in particular to prevent the layers formed from having an excessive porosity. Compacting individual layers can in each case be carried out before they are overprinted with a further layer. However, it is also quite possible to compact a plurality of layers in one step or first build up the electrode-separator assembly in completed form from individual layers and then compact the total assembly in one step.

Preference is also given to subjecting the assembly to a heat treatment, especially after it has been manufactured. Such a heat treatment has the purpose of removing any residual dispersion medium present from the assembly.

However, particularly preferably, preference can also be given to carrying out the heat treatment at a temperature at which the assembly and thus the individual two-dimensional layers of which the assembly is composed are sintered. In such a sintering procedure, the porosity of the assembly formed can be finely adjusted. In addition, it is possible for the organic additives required to process the dispersions and also further undesirable organic residues to burn out.

The assembly can subsequently be impregnated with an electrolyte. Electrolytes for the various electrochemical systems in batteries are adequately known and do not have to be explained in detail.

In an example of our process, the electrode-separator assembly is built up on a support substrate and, after manufacture, in particular after compacting and/or optionally the heat treatment, transferred into the housing provided for it. As a result of numerous functional parts (at least the electrodes and the separator) already having been integrated into the assembly, only very few assembly steps are necessary to manufacture the battery to be produced. In the case of the production of a button cell in which the halves of the housing function as poles, electric contacting of the electrodes is ideally no longer necessary.

Preferably, the support substrate is a thin metal substrate such as a metal foil or a metal mesh. This can serve as power outlet lead for the electrodes deposited directly thereon.

Alternatively, it is possible for the two-dimensional layers to be printed directly into the housing or into a part of the housing of the battery to be produced. In this case, transferring the assembly into the appropriate housing is no longer necessary.

Naturally, a battery produced by our process is also provided. The process is particularly well suited to the production of prismatic cells and button cells. Accordingly, the battery is also preferably a button cell or a prismatic cell.

As can be seen from what has been said above, our batteries have a housing in which the three-dimensional electrode-separator assembly formed by printing is arranged. In the simplest examples, this comprises only two electrodes and a separator, in particular in a stacked sequence, while in further examples it additionally comprises one or more power outlet leads.

Further features and advantages can be derived from the drawings and from the following description of some preferred examples. Features can in each case be realized on their own or in a combination of a plurality thereof in one examples. The preferred examples described are merely for the purposes of illustration and to give a better understanding and are not to be construed as any restriction.

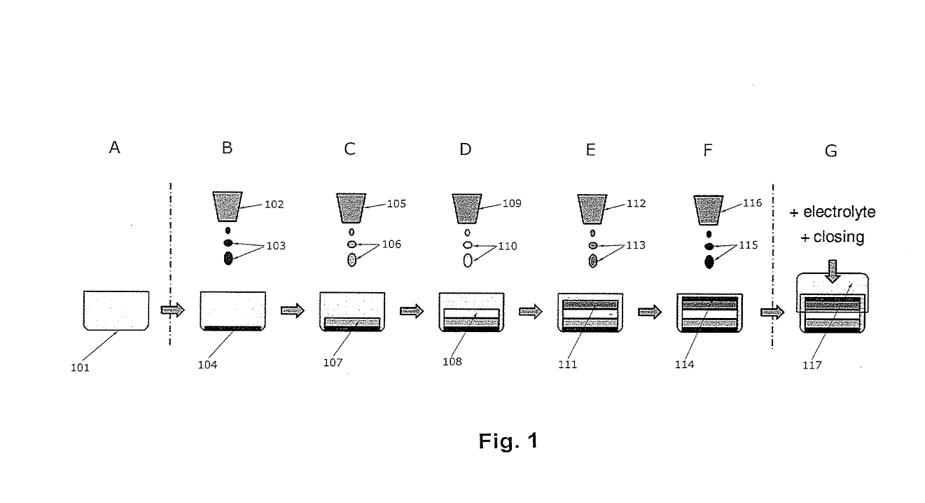

FIG. 1 schematically illustrates the process sequence of a preferred example of our process, which is employed to produce a button cell.
In step A, a housing lid 101 is provided.
In step B, a power outlet lead dispersion 103 is introduced into the housing cup 101 by the printing head 102. The power outlet lead 104 is formed on the bottom of the housing cup 101.
In step C, a first electrode dispersion 106 is introduced into the housing cup 101 from the printing head 105. The power outlet lead layer 104 is overprinted with this dispersion. The first electrode 107 is formed on the power outlet lead layer 104.
This is subsequently, in step D, covered with the separator layer 108 formed by the printing head 109 from which the separator dispersion 110 is ejected.
In step E, the second electrode 111 is formed on the separator layer 108 by the printing head 112 using the second electrode dispersion 113.
This is, in step F, finally overprinted with the current collector layer 114. This is formed from the power outlet lead dispersion 115 by the printing head 116.
In step G, the housing lid 101 filled with the electrode-separator assembly made up of the layers 104, 107, 108, 111 and 114 is pushed into the housing cup 117.

Before closing the housing, the assembly is generally dried and impregnated with a suitable electrolyte.

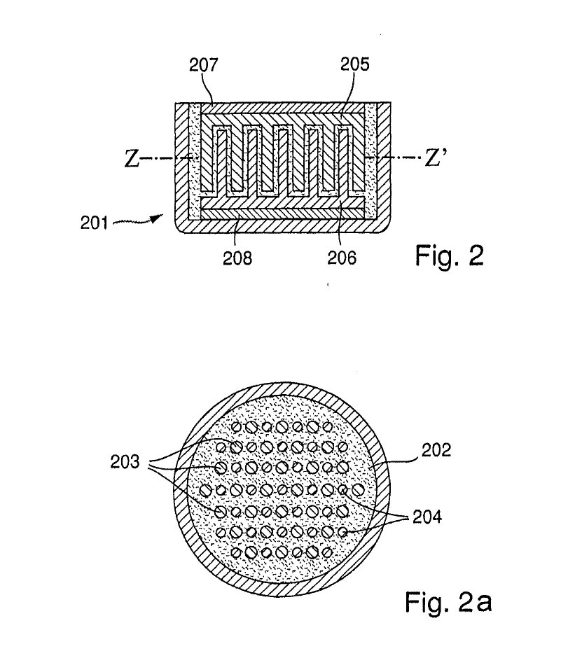

FIG. 2 illustrates a variant of the process in which an electrode-separator assembly 201 is made up not only exclusively of two-dimensional layers which have each been printed from only one of the dispersions. Instead, at least the middle part of the assembly 201 shown is formed by printing a plurality of layers having an identical base area and each having cut-outs at the same predefined positions on top of one another using a separator dispersion and filling these cut-outs partly with the first electrode dispersion and partly with the second electrode dispersion. In the cross-sectional view (section along the line Z-Z′) in FIG. 2a, a layer 202 of this type printed using a separator dispersion is shown. The cut-outs 203 are filled with the first electrode dispersion, and the cut-outs 204 are filled with the second electrode dispersion. Superposition of cut-outs filled with the same electrode dispersion makes it possible to obtain structures of the type shown in which the electrodes or parts of electrodes extend perpendicularly to the layer planes over a plurality of layers. The first electrode is denoted by the reference numeral 205, and the second is denoted by the reference numeral 206. At the end face, the assembly has the power outlet leads 207 and 208.

1-11. (canceled)

12. A process of producing a button cell having a housing and a three-dimensional electrode-separator assembly arranged therein, wherein the electrode-separator assembly comprises a first electrode, a second electrode having an opposite polarity to the first electrode and a separator separating the first electrode and the second electrode, the process comprising:
forming the assembly by sequentially printing two-dimensional layers with
a first electrode dispersion that produces the first electrode and/or
a second electrode dispersion that produces the second electrode and/or
a separator dispersion that produces the separator
on top of one another, wherein the layers each are printed either from only one of the dispersions or from a plurality of the dispersions.

13. A process of producing a button cell having a housing and a three-dimensional electrode-separator assembly arranged therein, wherein the electrode-separator assembly comprises a first electrode, a second electrode having an opposite polarity to the first electrode and a separator separating the first electrode and the second electrode, the process comprising:
forming the assembly by sequentially printing two-dimensional layers with
a first electrode dispersion that produces the first electrode and/or
a second electrode dispersion that produces the second electrode and/or
a separator dispersion that produces the separator
on top of one another, wherein the two-dimensional layers are printed directly into the housing or into a part of the housing.

14. A process of producing a button cell having a housing and a three-dimensional electrode-separator assembly arranged therein, wherein the electrode-separator assembly comprises a first electrode, a second electrode having an opposite polarity to the first electrode and a separator separating the first electrode and the second electrode, the process comprising:
forming the assembly by sequentially printing two-dimensional layers with
a first electrode dispersion that produces the first electrode and/or
a second electrode dispersion that produces the second electrode and/or
a separator dispersion that produces the separator
on top of one another, wherein the assembly is, after it has been built up, transferred into the housing.

15. A process of producing a battery having a housing and a three-dimensional electrode-separator assembly arranged therein, where the electrode-separator assembly comprises at least one first electrode, at least one second electrode having the opposite polarity to the first, at least one separator physically separating the at least one first electrode and the at least one second electrode and optionally at least one power outlet lead, the process comprising:
forming the assembly by sequentially printing two-dimensional layers with
a first electrode dispersion that produces the at least one first electrode and/or
a second electrode dispersion that produces the at least one second electrode and/or
a separator dispersion that produces the at least one separator and/or
at least one power outlet lead dispersion that produces the at least one power outlet lead
on top of one another.

16. The process as claimed in claim 15, wherein the assembly is formed from two-dimensional layers printed from only one of the dispersions and/or comprise a plurality of the dispersions.

17. The process as claimed in claim 15, wherein the dispersions used comprise:
the first electrode dispersion comprises a dispersion medium, a first electrochemical active material dispersed therein and a conductivity improver and/or a first electrode binder;
the second electrode dispersion comprises a dispersion medium, a second electrochemical active material dispersed therein and a conductivity improver and/or a second electrode binder;
the separator dispersion comprises a dispersion medium, electrically nonconductive fibers and/or particles dispersed therein and/or a binder; and
the power outlet lead dispersion comprises a dispersion medium, electrically conductive fibers and/or particles dispersed therein and/or a binder.

18. The process as claimed in claim 15, wherein at least one of the dispersions contains a crosslinkable polymer or a polymer precursor which can crosslink/polymerize under action of heat and/or radiation as binder.

19. The process as claimed in claim 15, wherein two-dimensional layers which have been printed using a dispersion comprising a crosslinkable polymer or a polymer precursor are heated and/or irradiated before they are overprinted.

20. The process as claimed in claim 15, wherein a dispersion medium present in a two-dimensional layer is at least partly removed before the layer is overprinted.

21. The process as claimed in claim 15, wherein the layers are compacted before they are overprinted.

22. The process as claimed in claim 15, wherein the assembly is subjected to a heat treatment.

23. The process as claimed in claim 15, wherein the two-dimensional layers are printed directly into the housing or into a part of the housing.

24. A battery having a housing and a three-dimensional electrode-separator assembly arranged therein, produced as claimed in claim 12.

25. The battery as claimed in claim 24, having a prismatic shape or is a button cell.
